(19) United States
(12) Patent Application Publication
(10) Pub. No.: US 2025/0333334 A1
(43) Pub. Date: Oct. 30, 2025

(54) WATER TREATMENT SYSTEM

(71) Applicant: POLLOSANO LTD, Rechovot (IL)

(72) Inventors: Eli AMAR, Rechovot (IL); Meir SHAMIR, Kiryat Ono (IL); Uri ALDUBI, Kiryat Ono (IL)

(21) Appl. No.: 19/194,302

(22) Filed: Apr. 30, 2025

Related U.S. Application Data
(63) Continuation of application No. PCT/IL2023/051340, filed on Dec. 31, 2023.

(51) Int. Cl. C02F 1/32; C02F 1/00; C02F 1/48; C02F 1/74

(52) U.S. Cl. CPC C02F 1/325; C02F 1/008; C02F 1/482; C02F 1/74; C02F 2201/3222; C02F 2201/3228; C02F 2209/38; C02F 2303/04

(57) ABSTRACT

The invention is a water purification system without use of chemical substances. The essential parts of the system are a chamber with inlet and outlet for flowing incoming and outgoing air into a water-containing tank; at least one UV radiation lamp; optionally a UV radiation reflection cover on inner wall of the chamber; at least one double magnetic ring pair; and a skeleton for occupying center volume of the chamber around central longitudinal axis of the chamber. The skeleton comprises inner space for accommodating the lamp and holding elements for holding the double magnetic ring pair(s) around the lamp. The UV radiation reflection cover is configured to amplify interaction of UV radiation with oxygen molecules in the incoming air. The double magnetic ring pair(s) is configured to intensify the local magnetic fields and increase the number and mean lifetime of radicalized oxygen molecules and improve water purification.

### TECHNICAL FIELD

This invention pertains to non-chemical water cleaning systems and particularly to a system and apparatus which utilize ambient air transformation into radicalized oxygen gas, which is generated for further water cleaning purposes.

### BACKGROUND

Water purification has turned an essential requirement due to continuous pollution of water and the need to supply drinkable water. Different methods, chemical and non-chemical, are suggested for water purification. Regarding non-chemical methods, prior art and systems disclosed therein involve only partial aspects of a chamber model for purifying water and related functionalities by producing a purifying reactive gas or air. Accordingly, in all previous prior arts, the integration of the system components comprising UV radiation sources, magnetic field generating sources and air flowing means into the chamber are decoupled as much as possible to obtain the system maximum efficiency and optimal performance. As an example, in U.S. Pat. No. 4,655,933 to Johnson the ferromagnetic elements, which induce the magnetic flux fields inside the air flowing chamber are located outside or at the corners of the chamber, presumably to eliminate any unwanted perturbation which may be introduced into the ambient air gas which is flowing from inlet to outlet of this chamber, and degrade the whole system performances. As a result, in the related embodiments disclosed in Johnson, the mutual interaction between the ambient air molecules and the magnetic field, induced by the ferromagnetic rods in the disclosed configurations, is limited by the air chamber diameters and by its geometrical shape. These parameters are designed according to different considerations, which include the required air capacity and water cleaning rate. Unfortunately, such design rules and architecture do not leave enough room/degree of freedom for the person skilled in the art to design and make a highly efficient system, which is optimized per the requirements of a certain application and corresponding client needs. Similarly U.S. Pat. No. 9,321,655 to Kolstad et al disclose similar method and apparatus, however with enhanced performances due to magnetic rods in an anti-symmetric configuration that induce larger magnetic flux on the oxygen gas component of air. Due to the usage of ferromagnetic rods, Johnson and Kolstad suffer from the following problems that degrade the performance of the ionization chamber: i. The magnetic field does not have a coaxial cylindrical symmetry, hence it introduces an non-concentric perturbation to incoming flowing ambient gas. The non-concentric distribution of radicalized gas results in a higher physical interaction between the chamber walls and ambient flowing gas profile which mimics the chamber cylindrical shape. As a result of this perturbation, a higher recombination rate is expected due to higher interaction between the oxygen radicals and ambient gas components. ii. To achieve maximum performance, the magnetic rods and related polarization need to be aligned with respect to the ionization chamber, with respect to other magnetic rods in a given site and between adjacent sites. To overcome this, Kolstad et al embedded the magnetic rods inside long magnetic tubes. The magnetic rods solve the alignment issue however also occupy a significantly high amount of volume inside the ionization chamber lowering its capacity to conduct the compress ambient air. As a result, any minor increase in the rods diameter, which may increase the magnetic field in the chamber, may yield a significant reduction of the free volume of the ionization chamber, limiting the option to optimize the ionization chamber performances.

To compensate the mentioned deficiencies, one can increase UV power specifications or the compressed gas level. However, this can yield in unwanted thermal instabilities and further degrade the ionization chamber performance.

All the required components in the ionization chamber, when correctly configured together may avoid unwanted side effects that can lower the system efficiency degrading its ionization rate and cleaning properties. Such unwanted side effects may be driven by unnecessary increase in the UV power radiation due to scattering and absorption and as a result, unwanted asymmetrical geometrical perturbation that limits the coupling between the UV and ambient gas. Alternatively, the UV power may be enhanced or the rate of compressed air increased. However, any change in the properties of the ionization chamber might modify thermal and other properties of the air flow and as a result degrade system efficiency. In another aspect, an inefficient magnitude of magnetic flux applied on oxygen paramagnetic gas molecules inside the chamber can result in inefficient system, which can function properly only at low compression values of the flowing air.

Moreover, a too high compression gas value or UV power may result in higher gas temperature, significant increase in recombination rate of oxygen gas phase radicals back to their natural diatomic and/or neutral state. This is due to a relatively increased interaction between the oxygen gas molecules and chamber sidewalls and between the radicalized oxygen gas molecules and the other neutral oxygen, nitrogen and other non-radical air molecules.

WO 2019/135239, which is assigned to the applicants of the present invention and incorporated herein by reference, describes a water purification system that does not use chemical substances. Its essential parts include a chamber that accommodates one or more pairs of magnetic rings arranged along the length of the chamber, a UV lamp at the center of the chamber and a skeleton that holds the magnetic rings and the UV lamp at its center. The configuration of this system is essentially a concentric one to minimally perturb the profile and distribution of the incoming and outgoing air. The results of water treatment with the radicalized oxygen in the chamber showed exceptional reduction in inorganic, organic and biological impurities and the water turned clear and transparent to a high level. It is assumed that these impurities break down to fragments or react with other impurity compounds or water molecules to produce precipitates. The purified water shows low levels of impurities, organic, inorganic and biological, and is drinkable by and particularly suitable for farm animals. However, it must meet higher standards under more strict codes to be suitable for use. To this end, field experiments showed that under particular circumstances, this chamber should be modified to provide a more efficient and/or increased production of radicalized oxygen to more effectively reduce the concentration of impurities to the required levels.

It is, therefore, an object of the present invention to provide an improved and efficient high performance non-chemical water cleaning system.

It is yet another object of the present invention to provide a water cleaning system with a radicalized molecular oxygen producing chamber with a concentric configuration and amplified UV radiation and magnetic field to improve the production of ionized allotrope oxygen gas as the cleaning agent, which is introduced into water.

It is yet another object of the present invention to provide a system in which coupling of variables that influence oxygen allotrope production enhances water cleaning efficiency by the system to further reduce concentration levels of impurities according to required standards.

It is yet another object of the present invention to provide an apparatus and a method which is scalable according to the volume of water reservoirs.

This and other objects and embodiments of the invention shell become apparent as the description proceeds.

### SUMMARY

The present invention pertains to non-chemical water purification, treatment and maintenance systems. In particular, the present invention pertains to systems which utilize modified air, which is radicalized/excited and introduced into a container of contaminated water with mechanical pressure pumps/compressor and gas guiding means. The aggressive electrical and chemical reaction of the air radicals and their related products with the contaminated water results in almost a complete elimination of the contaminations which are dissolved, precipitate, flushed and drained out from the system leaving a very high degree of purified water. Chemical water purification systems are well known in the prior art. However, such treatment produces only partial water purification with additional chemical bi-products that carry side effects. As opposed to these systems, the present invention does not utilize any supplemental materials such as chemical detergents or biocides, used for inorganic and organic infections, and does not have any side effects or unwanted bi-products. Similar non-chemical prior art systems are disclosed such as those in U.S. Pat. Nos. 4,655,933 and 9,321,665 as discussed above.

WO 2019/135239, which is assigned to the applicants of the present invention and incorporated herein by reference, describes a water purification system that does not use chemical substances. Its configuration includes the following:
a chamber comprising inlet and outlet for flowing incoming and outgoing air into the chamber and out of the chamber and into a water-containing tank;
at least one UV radiation lamp;
at least one pair of magnetic rings; and
a skeleton configured for occupying the center volume of the chamber from top to bottom around central longitudinal axis of the chamber, where the skeleton comprises inner space for accommodating the at least one UV radiation lamp and at least one pair of holding elements for holding the at least one pair of magnetic rings around the at least one UV radiation lamp,
wherein outer diameter of the magnetic rings is smaller than inner diameter of the chamber and where the distance between every neighbor pair of the holding elements on the skeleton generates local magnetic fields upon placing these pairs of magnetic rings on the holding elements,
where the purification system comprises concentric configuration to minimally perturb profile and distribution of the incoming and outgoing air, the at least one pair of magnetic rings are positioned in parallel relative each other and configured to induce maximal concentric magnetic flux field on molecules of the flowing incoming and outgoing air.

The configuration of this chamber in WO 2019/135239 showed exceptional reduction in inorganic, organic and biological impurities and the water turned clear and transparent to a high level. It was assumed that these impurities break down to fragments or react with other impurity compounds or water molecules to produce precipitates. The purified water showed low levels of impurities, organic, inorganic and biological, and were drinkable by and particularly suitable for farm animals. However, more heavily contaminated water raised the need to enhance the chamber's capacity to generate a greater number of radicalized oxygen molecules per a given volume of incoming and outgoing air for attacking biological contaminants in particular and eliminating them from the water reservoir in order to make it drinkable by farm animals. Accordingly, obtaining further purification of water to meet higher standards and code, required to modify this chamber's features to increase the probability of generating radicalized oxygen molecules and their mean lifetime in their excited state. It was assumed that an increase in these two parameters would increase the number of radicalized oxygen molecules per a given volume of air, and the level of water purification as a result of the diffusion of the radicalized oxygen into the water.

The main problem was how to make such improvements in a confined chamber without modifying its dimensions and inner structure. Maintaining the current size and structure and the inner configuration of the chamber that accommodates the magnetic rings and UV radiation generating lamp while increasing its radical molecular oxygen capacity benefits the system's compact size. In turn, the system's improved capacity benefits its capability to treat a large range of volume of water reservoirs without enlarging the volume of the system in general and the chamber in particular. It follows that increasing the yield of radicalized oxygen molecules requires alterations in the inner parts of the chamber under the constraints of keeping its volume and the general physical model, which we assume applies for the chamber's configuration.

The present invention, therefore, comprises the following improvements to the chamber without modifications to the chamber's basic dimensions, shape and inner configuration. Further, the fluid interface with the water tank and air pump and electrical contact also remained unchanged, thus enabling the chamber to maintain the same air flow parameters inside and connect to the water tank with the same means:
1. To enhance radiation impact on the incoming oxygen molecules the inner surface of the chamber wall was covered by an electromagnetic radiation reflecting cover, which is suitable to reflect the UV radiation at the wavelength range that the UV lamp generates and radiates. It was assumed that this back radiation mirrored by the reflecting cover would interact with a larger number of oxygen molecules at any given volume inside the chamber and electrically excite a larger number to a certain proportion. Even if such proportion is not linear, the increase in the number of radicalized oxygen molecules, the addition of radicalized oxygen was believed to contribute to the total yield. Such increase can be suitably represented by a coefficient between 0 and 1 multiplied by the volume concentration of oxygen molecules in the case of a non-mirrored UV radiation in the former configuration. Alternatively, a coefficient of 1.X may be used, where X is between 0 and say 0.99, for the improved chamber, where the configuration of the previous chamber is taken as a baseline and represented by the coefficient value of 1.

The number of magnetic rings for a pair was doubled. Namely, an additional ring with a certain magnetic strength is added for every ring in a pair of magnetic rings as shown in the Figures. This generates a stronger magnetic field but maintains its spatial locality relative to the magnetic fields that neighbor magnetic ring pairs generate around the main axis of the chamber. Here we assume that the intensified local magnetic field allows a larger number of radicalized oxygen molecules to aggregate in a confined volume of the magnetic field within the chamber. We further assume that the mean life-time of the radicalized oxygen molecules is proportional to the size of the aggregate of radicalized oxygen molecules in the magnetic field. The larger the aggregate the greater the mean life-time of the radicalized oxygen molecules. This is because a larger aggregate enables to maintain the excited state of oxygen molecules a longer time by collisions between molecules in the excited state. The less oxygen molecules in the ground state in the aggregate or the higher the ratio between excited molecules and incoming molecules in the ground state in the confined volume of the magnetic field, the greater mean life-time of the excited molecules and the less number of excited molecules that return to the ground state before leaving the chamber to the water tank. In one embodiment of the present invention, the radicalized oxygen molecules generating chamber for water purification and treatment system has a cylindrical geometrical shape comprising the housing sleeve, which has a cylindrical geometrical shape, where the housing frame has a cylindrical geometrical shape.

In another embodiment of the present invention, the radicalized oxygen molecules generating chamber for water purification and treatment further comprises sets of concentric cylindrical ferromagnetic rings arranged in a similar relative magnetic polarity or at relative opposite magnetic polarities at the top, center and bottom locations along the tube chamber main axis, wherein each set comprises magnetic rings with opposite magnetic polarities. The rings are mechanically connected to the skeleton carrier with base holders.

In still another embodiment of the present invention, the magnetic rings are arranged in pairs that generate spatially local magnetic fields within the volume of the chamber. Furthermore, in still another embodiment, the rings are arranged in sets, where each set comprises a pair of double rings facing each other in opposite or same polarities.

In another embodiment of the present invention, the ionization chamber of the water purification and treatment system is made of aluminum material.

In another embodiment of the present invention, the ionization chamber of the water purification and treatment system is coated with PVC (Polyvinylchloride).

In still another embodiment, the inner wall of the chamber is covered with an electromagnetic radiation reflecting cover, particularly electromagnetic radiation in the UV range. Specifically, the cover is made of an aluminum foil. Other options for reflecting the UV radiation back include anodized aluminum, stainless steel and bright paints that reflect UV radiation.

In another embodiment of the present invention, the housing frame is made of aluminium and its UV lamp and ferromagnetic element skeleton carriers including the attached holders are made of steel/aluminium and are coated with stainless steel. In another embodiment of the present invention, the radicalized oxygen molecules generating chamber is connected to a venturi pump for vacuum the active air from the chamber into the water treated pipe connected to drinking water systems of animals or irrigation systems or water reservoirs.

In another embodiment of the present invention, the housing frame of the water purification and treatment system is made of or coated with stainless steel.

In another embodiment of the present invention, the internal surface of the chamber comprises a housing sleeve frame, wherein the internal side of the sleeve housing frame and the top and bottom covers are coated with TiO₂.

In another embodiment of the present invention, the water purification and treatment system further comprises a plurality of UV lamps in suitable design and configuration.

In another embodiment of the present invention, the water purification and treatment system further comprises an air diffuser that is connected on one side to the air pump and the ionization chamber inlet on its other side.

In a further embodiment of the present invention, the water purification and treatment system comprises a venturi air pipe line, which is connected on one side to the air pump or air diffuser outlet and the ionization chamber inlet on its other side through an adaptor.

In another embodiment of the present invention, the external side of the ionization chamber comprises air and electrical inlets and outlets, which are isolated with a Teflon material for vacuum isolation purposes.

In another embodiment of the present invention, the water purification and treatment system further comprises a pre-filtering apparatus which is configured to clean the ambient air from impurities and contaminations before being injected into the cylindrical chamber.

In another embodiment of the present invention, the water purification and treatment system further comprises a water cooling system.

In another embodiment of the present invention, the water purification and treatment system comprises several adaptors, which are connected to the chamber air inlet and outlet holes and other electrical holes. The adaptors are designed with threaded sides to enable a highly strong screwing mechanical attachment to the external pipes or electrical wire connections.

In another embodiment of the present invention, the radicalized and radiated air is pumped from the external pipe into the water tank or container, wherein the water may be stirred to achieve better results so that the pumped radicalized air is capable of producing the desired kinetics within the water.

In another embodiment of the present invention, the radicalized air purifies the water by the formation of hydrogen peroxide (H₂O₂) through aggressive reaction of oxygen radical molecules that react with the water molecules and contaminants within the water.

In another embodiment of the present invention, the water purification is done by direct interaction between the oxygen radical allotropes, which are produced in the chamber and diffuse into the water in their gaseous phase, and the contaminants within the water.

In another embodiment of the present invention, the water purification and treatment system further comprises a module that drains and flushes out contamination debris and precipitates from the purified water.

In another embodiment of the present invention, the water purification and treatment system is connected to various types of water reservoirs, systems and conduits such as drinking water supply systems, swimming pools and water piping, and may be used in various fields of industry, farming, agriculture, gardening recycling and urban use.

In another embodiment of the present invention, the water purification and treatment system injects compressed ambient air into the chamber, and transforms it into radicalized/excited gas phase that comprises molecular oxygen allotrope. The system further carries the allotrope through the chamber outlet and an external pipe into a water container or tank.

In one aspect, the present invention pertains to a non-chemical water purification treatment system. In another aspect of the invention, the system is configured for treating and maintaining polluted or contaminated water using modified ambient air without any additional usage of supplemental materials such as chemical detergents or biocides.

In one embodiment of the present invention, the system is provided in a compact closed chamber for safety and mobility. In another embodiment of the present invention, the system is connected to various types of water reservoirs, systems and conduits such as drinking water supply systems, swimming pools and water piping. In still another embodiment, the system is used in various fields of industry, farming, agriculture, gardening, recycling and urban use.

In one particular aspect of the present invention, the system injects and compresses a modified ambient air through a cylindrical tube chamber that electrically radicalizes the gases it contains, where said ambient air comprises mostly nitrogen and oxygen gas molecules. In a further aspect of the invention, the paramagnetic properties of the oxygen component of the ambient air comprising mostly diatomic oxygen gas molecules, are employed to focus and concentrate the oxygen molecules at certain locations in the tube chamber. This is done with permanent magnetic flux fields, which are located inside the ionization chamber and applied with a specific configuration of concentric ferromagnetic ring shape elements. These rings are located inside the cylindrical tube chamber along its main axis.

In a still further aspect of the invention, the oxygen molecules are exposed to UV light which is radiated from a UV light source comprising two internal lamps with two different wavelength ranges of UV light, 180-195 and 240-280 [nm] respectively. The UV light sources generate hemolytic cleavage of chemical bonds in the oxygen molecules, and induce it into several stable states of radical oxygen molecule products that compose an allotrope of oxygen molecules at different electrical excitation states.

In one particular aspect of the invention, the stable oxygen radicals flow out of the cylindrical tube chamber by an applied external pressure and are directed into the water purification and treatment tank. In still another embodiment, the cylindrical tube chamber is made of an inert material or coated within with inert material such as TiO₂ designed for physical protection from the flowing radicalized oxygen gas.

In still another aspect of the invention, the radicalized and radiated air is pumped into the water, where the water is stirred for better results so that the pumped radicalized air can produce the desired kinetics within the water.

In still another aspect of the invention, the radicalized air purifies the water by the formation of hydrogen peroxide (H₂O₂) through aggressive reaction of radicalized oxygen molecules that react with the water molecules and contaminants in the water.

In still another aspect of the invention, in addition to the hydrogen peroxide interaction, there is a direct interaction between the oxygen allotrope radicals and the contaminants.

In a still another aspect the invention, the system produces high degree of purification and quality of water without introducing chemical and/or biological organic or inorganic bi-products or other side effects as in chemical water cleaning reactions. In still another aspect of the invention, the system continuously supplies the radicalized oxygen in the air to the water to ensure constant purification and supply of purified water.

The present invention and disclosed system are designed for treatment, purification and maintenance of polluted or contaminated water inside various large water housing containers, utilizing modified ionized air products without any other supplemental chemical materials such as chemical detergents or biocides used for inorganic and organic infections as done in several previous works.

### Apparatus

The current system injects a compressed ambient air into an inlet of a cylindrical tube shape chamber to produce modified ambient air, transformed through a radicalization process upon exposure to UV light radiation at two different wavelength ranges of UV light 180-195 [nm] and 240-280 [nm]. The ambient oxygen gas is highly reactive, where its paramagnetic properties are utilized to direct, focus and concentrate it at certain locations using external magnetic flux and magnetically activate it to higher magnetization levels required to enhance excitation process by UV radiation into its radical allotrope phase. The magnetic flux is generated by a certain configuration of concentric ferromagnetic ring shape elements at certain locations inside the chamber. The ambient air, particularly the paramagnetic oxygen molecules which are magnetized by the magnetic field of the rings, is further radiated by the UV light radiation source, which induces its radical higher states of energy. The radicalized oxygen phase comprises an allotrope of several ionized and excited oxygen states and is directed to the tube chamber outlet by external pressure and pumped out into the contaminated water. The water may be stirred, producing the desired kinetics required to improve the solubility of the ionized oxygen radicals, which are pumped into the water. It is assumed that the modified air purifies the water by the formation of hydrogen peroxide (H₂O₂) through aggressive reaction of radical oxygen gas molecules, which further react with the contaminants, or alternatively by a direct interaction between the oxygen gas molecule radicals and the contaminations. It is assumed that some part of the oxygen radicals are concentrated in small bubbles which serve as agents that lead them to direct interaction with water contaminations.

The contaminants are either chemically modified or broken into harmless debris which may then be filtered, flushed and drained out of the water containers or precipitate and solidify on the water tank floor and walls. Alternatively, such reaction products are benign and can be consumed by farm animals and disposed of in a natural way. The system continuously supplies the modified (active) air in a small bubbles formation to the water to ensure constant purification and supply of purified water.

### Model

Modelling and designing non-chemical water treatment and purification systems such as the one presented in this application is in general a highly complex and non-trivial task which involves various considerations such physical, mechanical and other design considerations. Most of these considerations are derived mainly from several different physical mechanisms which affect directly the performance of the purification system, however also including some mutual interactions between these mechanisms. Hence, in order to yield a highly efficient water treatment and purification system, it is required to correctly employ these physical mechanisms to the ambient air molecules and in particular the paramagnetic oxygen gas molecules, while they flow/propagate through the ionization chamber. In WO 2019/135239 we detailed these physical mechanisms and related considerations. The advanced water treatment system of the instant application follows the lines and limitations of the model, which were set in WO 2019/135239. However, exceeding these limitations, required to intensify the means for increasing production of molecular oxygen radicals without breaking the model as described in WO 2019/135239. Balancing between this goal and limitations or the basic structure of the water treatment system is an objective of the instant invention.

The magnetic field configuration comprises a plurality of magnetic sites, each site is configured to accommodate one pair of double magnetic rings in a similar or opposite magnetic polarity. In a further embodiment of the present invention, the magnetic field induced by the rings in each magnetic site varies from 10⁻³ to 10⁺⁶ gauss with sufficient magnetic flux, which is required for a given rate of radicalization/excitation at a certain air compression level and chamber parameters such as geometrical shape and design, internal architecture, ambient air flow properties, including kinetics, air paramagnetic and thermal properties, magnetic field distribution, intensity and flux field and UV radiation field which induces the ambient air into radicalized/excited state. In a further embodiment of the present invention, each magnetic site comprises a pair of double magnetic rings with geometrical shape, size, and polarities. In still another embodiment, the contribution of the configuration of the magnetic site to the magnetic field and magnetic field flux in the chamber free volume, including close to its sidewalls, and corresponding contribution in proximity to the magnetic site are considered for inducing radicalization/excitation of air.

In a one preferred embodiment of the present invention, the chamber has a cylindrical shape with two different volumes and lengths of 892 and 430 mm, with similar internal and external diameters of 63.4 mm and 73.15 mm. In still another embodiment, the ferromagnetic rings are made of NdFeB (Grade N42) material coated with Ni—Cu—Ni (Nickel) and have a width of 3.1 mm with external diameter of 31.75 mm, internal diameter of 19.05 mm and thickness of 6.35 mm. In still another embodiment, the diameters of the internal and external pipes at the input and the output of the chamber are 10 mm. The UV lamps have lengths corresponding to the chamber lengths with nominal powers of 21 and 39 watts, respectively. The water reservoir for purification is in volumes in the range of 1000-10000 litters.

In one embodiment of the present invention, the magnetic rings are made of ferromagnetic materials made from rare earth magnets. In particular, the materials are selected from Nd₂Fe₁₄B, SmCo₅ Sm₂Co₁₇, composite magnetic materials such as BaFe₁₂O₁₉, MnBi, Ce(CuCo)5, a strong permanent magnets such as, Alnico IV/V and Alcomax, which are trade names for composite materials made from alloys of aluminium, nickel and cobalt with iron with additional small amounts of Cu, Ti and Nb and ferrite materials of ferrimagnetic materials such as Fe₂O₃, and Fe₃O₄. In a further embodiment of the present invention, the magnetic field configuration is generated by a plurality of double magnetic ring pairs accommodated by a plurality of magnetic sites, wherein each magnetic site comprises one pair of rings comprising one ring made from one of the magnetic materials listed above and one ring made of a metallic material that can be magnetized under induced external magnetic field, such as iron and steel.

The air and gas thermal properties are assumed to be same as in the basic system of WO 2019/135239. Internal interactions between gas molecules are assumed to intensify significantly, which expresses in the corresponding purification results. Properties such as gas flowing kinetic properties, internal properties inside the ionization chamber, which are affected by the chamber geometrical properties, such as its geometrical shape, dimensions, internal design and materials from which it is made are assumed not to be affected. These introduce constraints on the physical model of the system but still obtain a higher yield without breaking it. One particular constraint is lack or at least minimal overlap between neighbor magnetic fields inside the chamber. This is an important demand, which is aimed at maintaining molecular oxygen allotropes at a steady state within local magnetic fields along the length of the chamber. On the other hand a greater volume of allotropes is assumed to form due to the stronger local magnetic fields. This raises concerns of interaction that might occur between pockets of molecular oxygen allotrope neighbor pockets.

A UV radiation reflection cover on the inner wall of the chamber introduces a factor of amplification of the exposure of the incoming air to the radiation and an increase of response of oxygen molecules in the form of excitation. An increase of yield is expected from this back reflection of radiation into any known amount of the incoming air.

A double ring configuration of pairs of magnetic rings multiplies the basic generation of radicalized oxygen molecules by a certain factor that reflects the stability of any known amount of radicalized oxygen molecules and increase in their mean lifetime. An improvement in water purification is proportionally expected.

Considering the previous modeling, we suggest the following embodiments: In one preferred embodiment of the present invention, we propose a fully concentric design for said system comprising a tube shape cylindrical ionization chamber, cylindrical elongated UV radiation lamp and at least one magnetic site comprising a pair of double magnetic rings which are located symmetrically around the chamber central axis. The double magnetic rings are positioned on a skeleton aluminum structure which is designed to hold them in a specific configuration aligning them relative to the ionization chamber central axis, other rings in the specific magnetic site, and other magnetic sites in the ionization chamber. The skeleton structure, including its localized magnetic sites, is designed to minimally perturb the profile and distribution of the incoming flowing ambient and radicalized air components. The magnetic rings can be positioned in parallel, symmetric or anti-parallel, anti-symmetric, magnetic polarization and are configured to induce a maximal concentric magnetic flux field on the compressed air flowing molecules. The magnetic rings radius and shape are defined according to specific requirement of the magnetic flux field, minimizing as well the interaction with the flowing gas. As a result, the radicalized/excited gas profile mimics the magnetic field concentric profile and hence minimally interacts with ambient air flowing components, significantly reducing their mutual interactions and interactions with the chamber walls, internal skeleton and rings. The chamber diameter and length, diameter of the UV radiation lamp and length are selected according to bench mark requirements of required compression level of gas which are predefined by a certain required application. These specifications also concern the required operation power and cleaning rate of water of said certain application. After setting these parameters, the magnetic field profile and distribution are set and optimized to achieve the required cleaning in a certain air compression level. As specified, in the current design, the chamber benefits from the concentric design of the magnetic field which significantly reduces the specified interaction of the ionization chamber mentioned above.

### Experimental Comparative Setup

Three sets of experiments were carried out outdoors throughout a period of about 18 months at different weather conditions. A water container was left on a rooftop with western exposure to solar radiation and open air with intensity and duration that depended on the changing seasons. The water accumulated organic, inorganic and biological contaminations over time. This container was used as a source for contaminating fresh water and making comparative tests of the efficiency of purification with different setups of the previous and current water treatment systems.

The first experiment was carried out in the late days of the summer season, at the end of August 2022, in Israel, where humidity and temperature were still high and exposure to solar radiation was intense. Such conditions encourage the proliferation and multiplication of bacteria and microorganisms in the water and the accumulation of dirt. The second experiment was carried out at the peak of the Israeli winter, in the beginning of January 2023, which was characterized with low temperatures, less daylight hours and a constantly cloudy sky. It was reasonably assumed that proliferation of the biological mass in the water slowed down in this season. The third test was carried out on late October 2023, at the entering to the autumn season in Israel, which wss characterized with mild temperatures, dry air and gradually diminishing exposure to sun radiation. Under such conditions, reduction in the proliferation rate of bacteria and microorganisms and accumulation of dirt in the water was reasonably assumed.

The description above sets the weather background to the experiments, which were carried out at the dates mentioned above. The impact of the weather conditions on these experiments will be discussed in the analysis of their results.

The following details the experimental setup for comparing the yield of the previously developed water treatment system in WO 2019/135239 with the yield of the water treatment system of the present invention with intensified magnetic field and wall radiation reflecting covers.

Equipment: At least two barrels with a volume of 80 litters each, a corresponding number of water treatment systems as detailed above and corresponding pairs of air diffusion stones for diffusing air bubbles containing radicalized molecular oxygen into the water reservoirs in the barrels were used to set up the comparative experiments.

Pre-treatment procedure: All barrels were thoroughly washed with streaming water to discard accumulated rust, algae, moisture and other precipitates from the interior side of their walls and floor. After cleansing, every barrel was filled with 80 litters of fresh water.

Contamination procedure: The barrels were placed on the rooftop of the building with western exposure and in spots with generally uneven conditions of exposure to sun and wind, depending also on the number of barrels that had to be accommodated on the surface of the roof. This was due to several conditions of the surroundings, including space limitations on the roof; a relatively less number of daylight hours in the winter season, particularly solar exposure hours; western exposure of the rooftop, which caused an uneven spatial exposure to solar radiation and therefore uneven distribution of solar energy invested in the water inside the barrels. Due to the western exposure, the roof space was shaded most hours of the day except for particular locations, which were directly exposed to the sun. This is believed to have caused the differences in the count of microorganisms in the initial sampling and will be discussed further in the description.

### The August 2022 Experiment

A water tank containing still water that accumulated organic, inorganic and biological contaminations, particularly microorganisms and bacteria, for a period of about 18 months was used to intentionally contaminate the water in all the barrels. A sample of 0.5 liter was taken from the tank of contaminated water for every water barrel and introduced into the fresh water therein. The water in the barrels was mixed vigorously to obtain a homogenous dispersion of the 0.5 liter of contaminated water in the 80 liters of the fresh water in every barrel. After mixing, the mixed contaminated water in the barrels was allowed to stand still for 24 hours. The barrels were put on a roof with western exposure that created uneven exposure to the sun. Certain areas of the roof were shaded most hours of the day and others more exposed to solar radiation. The exposure of the barrels to the sun depended, therefore, on their location on the roof and their number, which required making enough place for all of them.

In general, it is known that an exposure to solar radiation encourages and participates in photo-chemical and photo-biological processes in the water. The inventors of the present invention, therefore, concluded that the uneven spatial distribution of intensity and duration of exposure to the sun contributed to the different levels of proliferation of bacteria and microorganisms in the contaminated water over time. Therefore, different levels of initial state of contamination were obtained from the initially evenly contaminated water after 24 hours. This factor was considered in analyzing the experimental results obtained. The measurements and analysis focused mainly on the biological contaminants, which were apparently the type of contaminants most affected by solar radiation on the one hand and radicalized molecular oxygen on the other hand. The biological contaminants and their response to the products of the water treatment system were actually used as indicators for the effective operation of the system.

Sampling: After 24 hours of exposure to solar radiation and other weather conditions, e.g., humidity, wind, the contaminated water was vigorously stirred again in every barrel to obtain a homogenous distribution of the contaminants before sampling. Water samples were taken from every barrel. After the initial sampling, a water treatment device of the instant and previous inventions was connected in fluid communication to one of the barrels and powered on for 24 hours. Final sampling was made after 24 hours of continuous operation of the water treatment devices and diffusion of radicalized air containing radicalized oxygen molecules into the water. The initial and final water samples that were taken from every barrel were tested in a lab for concentration of biological, organic and inorganic content.

Table I below presents the results of the summer 2022 experiment. The first entry in Table I shows the values of the before and after purification of the water treatment system with the previous configuration of the chamber, also termed regular herewith, and the water treatment system with the intensified configuration of the chamber of the instant invention.

Several factors were considered in evaluating the measured results. As shown, a relatively high pH value indicates a basic aqueous environment. A relatively high level of dissolved molecular oxygen in the water suggests strong presence of biological organisms that consume oxygen for different processes, e.g. photosynthesis, breathing. The value of the initial CFU (Colony Forming Units) count is relatively in the medium range, corresponding to the basic environment in the water, the period of only a few months passed from placing the source tank on the roof and the number of winter months included in this period with low levels of exposure to solar radiation and biological activity.

The absolute values of the CFU count for the regular and intensified water treatment systems are not considerably lower than the initial count before treatment. These results suggest competing processes of proliferation and multiplication of microorganism colonies in the water as a result of exposure to environmental condition and their destruction in the purification process. The basic state of the water and the concentration of levels of dissolved oxygen reduced to similar values in both the regular and intensified systems. However, the relative CFU values clearly show a 30% decrease of the intensified system relative to the regular one. This can be attributed to the stronger magnetic field in the intensified system that operated in an environment that encouraged multiplication of microorganisms and under weather conditions more favorable to such proliferation. Although the regular device also showed a relatively effective bactericide activity, it was still inferior to the effectiveness of the intensified system with the stronger magnetic field.

One should note the significant reduction in the level of the dissolved molecular oxygen for the two systems. This could be attributed to the destruction of biological and chemical contaminants by the radicalized oxygen molecules. This destruction caused a decrease in consumption of oxygen in life-related processes and chemical reactions that occurred in the water in the presence of the molecular oxygen radicals. Such reactions involved the breaking of chemical bonds in organic, inorganic and compounds of and biological organisms and microorganisms that form the contaminating mass in the water. On the other hand, the dissolution of molecular oxygen in the water was not sufficient to cover for the deficiency that the aggressive reaction of the oxygen radicals generated.

TABLE I
Aug. 30/Sep. 4, 2022 - Regular v. Intensified

| Barrel | | Dissolved O₂ | General Count | |
|---|---|---|---|---|
| No. | pH⁽⁴⁾ | (mg/L)⁽⁵⁾ | (CFU/ml)⁽⁶⁾ | Comments |
| 1⁽¹⁾ | 9.7 | 14 | 18000 | Throughput of |
| | | | | incoming air - |
| | | | | 8 liter/min |
| 2⁽²⁾ | 8.7 | 7.88 | 12000 | |
| 3⁽³⁾ | 8.4 | 7.66 | 16000 | |

Quality control terms:
⁽¹⁾Source
⁽²⁾Intensified Device
⁽³⁾Regular Device
⁽⁴⁾pH measurements were made according to MOH Water Sampling guidelines.
⁽⁵⁾Dissolved O₂ measurements were made according to MOH Water Sampling guidelines.
⁽⁶⁾General count of microorganisms was made according to PP/SM - 9215 B standard.

### The January 2023 Experiment

Moving on to the Winter 2023 experiment, Table II below details the pH, dissolved molecular oxygen and biological organisms count for the intensified system with the stronger magnetic field. The first and second entries show the pre- and post-treatment measurements, respectively. The basic character of the water medium is practically unchanged and a mild increase in the levels of dissolved molecular oxygen in the water is observed. This might be considered a discrepancy from the expected decrease in dissolved molecular oxygen, but could be understandable in light of the phenomenal difference between the pre- and post-CFU counts, i.e., almost eight times decrease in count. A possible explanation is that a larger concentration of extremely aggressive molecular oxygen radicals relative to the summer 2022 experiment was released into the water. Due to the significantly more efficient production of the intensified chamber with stronger magnetic fields, a superfluous concentration of such molecular oxygen radicals diffused into the water, part of which reacted aggressively with the biological mass in the water and a residual part decayed back to the electrical ground state. The conclusion from the combined experimental and environmental data suggests that the intensified system shows a significantly better performance than the regular one. Although a comparative test was not made in the winter 2023 experiment, one can deduce this conclusion based on the results of the summer 2022 and autumn 2023 experiments, the latter of which is discussed below.

Another observation concerns the high CFU count in the pre-treated entry. Compared with the CFU count in the summer 2022 experiment, this clearly proves the rapid accumulation of biological organisms and microorganisms in the water with time and a favorable hot and humid weather. The source tank, therefore, doubled its content of biological contamination in the period of time between summer 2022 and winter 2023. Facing this growing population of biological mass in the water, the water treatment systems must show improved performances to lower the levels of biological contamination to acceptable ones. An intensified water treatment system with a higher throughput is apparently needed to this end.

TABLE II
Jan. 3, 4, 8, 2023 - Intensified

| Barrel | | Dissolved O₂ | General Count | |
|---|---|---|---|---|
| No. | pH⁽³⁾ | (mg/L)⁽⁴⁾ | (CFU/ml)⁽⁵⁾ | Comments |
| 1⁽¹⁾ | 7.8 | 8.82 | 33000 | |
| 2⁽²⁾ | 7.8 | 9.4 | 4200 | |

Quality control terms:
⁽¹⁾Before activation of purification system.
⁽²⁾After activation of purification system.
⁽³⁾pH measurements were made according to MOH Water Sampling guidelines.
⁽⁴⁾Dissolved O₂ measurements were made according to MOH Water Sampling guidelines.
⁽⁵⁾General count of microorganisms was made according to PP/SM - 9215 B standard.

### The October 2023 Experiment

Table III below details the chamber configuration for six water treatment systems which were used in this water purification treatment test.

Sampling: Six barrels were used for the autumn 2023 experiment. Since the local water streaming system is old, 200 liters of water were streamed through the water pipes to discard of rust and precipitates before filling the barrels. The barrels were placed on a roof with western exposure. Some of them were shaded most of the daylight hours. Others were more exposed to the sun radiation during day time. Every barrel was filled with about 80 liters of water. After filling the barrels with fresh water, 0.5 liter of contaminated water was taken from the vigorously stirred source tank for every barrel and introduced into the barrels. The contaminated water in the barrels was stirred vigorously. Then the barrels were left for 24 hours. Six samples were taken from the water in the six barrels, one sampling from every barrel. The samples were taken to the lab and kept at a low temperature, 2-8° C., and with minimal or no exposure to light.

TABLE III

| Barrel | Device | Magnet | Reflector | |
|---|---|---|---|---|
| No. | Type | Configuration | Cover | Comments |
| 1 | Regular | N-N, anti-symmetric | None | |
| 2 | Regular | N-N anti-symmetric | Aluminum | |
| | | | cover | |
| 3 | Intensified | N-N anti-symmetric | None | Throughput of |
| | | | | incoming air - 8 |
| | | | | liter/min |
| 4 | Intensified | N-N anti-symmetric | None | Throughput of |
| | | | | incoming air - |
| | | | | 16 liter/min |
| 5 | Intensified | S-S anti-symmetric | None | |
| 6 | Intensified | N-N anti-symmetric | Aluminum | |
| | | | cover | |

After sampling, six water treatment systems, two regular and four intensified were connected to the six barrels, one water treatment system for every barrel. The water treatment systems were connected to the barrels in fluid communication with the water in the barrels. The water treatment systems were then turned on simultaneously and left to operate continuously for 24 hours. After 24 hours, the water in the barrels was again stirred vigorously to obtain a homogenous mixture. Six samples were taken again from the barrels, one sample from every barrel. The samples were taken to the lab and kept at a low temperature, 2-8° C., and with minimal or no exposure to light. The pre- and post-treatment samples were then tested for pH, concentration of O₂ dissolved in water and CFU.

Tables IV and V below present the pre- and post-results of the operation of the water treatment systems for the purification of water in the six barrels, respectively. The pH is practically neutral in all of the barrels before diffusing radicalized oxygen molecules into the water. This can suggest a balance between the creation of waste by-products and consumption of organic compounds in the life cycle of biological organisms and microorganisms and chemical reactions that involve organic and inorganic compounds. The concentration of dissolved O₂ in all barrels also fluctuates around a value of ˜7 mg/L. These values of pH and a relatively average concentration of dissolved O₂ suggest an acid-base balance that creates a life-supporting aqueous environment, which enables the proliferation and multiplication of biological organisms and microorganisms. The CFU values vary significantly in the barrels. As detailed above, this relatively broad range of CFU values can be attributed mainly to the different levels of exposure to solar radiation due to the different spots on which every barrel was placed on the roof. The large difference between the concentrations of biological organisms and microorganisms in the barrels raises the need to include this factor in analyzing the results of purification of water with radicalized molecular oxygen. Namely, the drop from a relatively high CFU is more difficult than a drop from a relatively low CFU.

Review of the CFU values measured in all three experiments show that the lowest and highest CFU values of the autumn 2023 experiment deviate significantly from the range of values obtained in these experiments. The range of CFU values is between about 12,000 and 34,000, while the lowest and highest values of the autumn 2023 experiment are 8,700 and 60,000 CFU, respectively. These values were, therefore, considered as discrepancies in analyzing the pre- and post-treatment measurements. This may probably be attributed to areas of more diluted or concentrated areas in the respective barrels from which the samples were taken and despite the vigorous stirring of the water before sampling. Other variables may be considered but these extreme measurement results were taken as reference to the pre- and post-measurements within the persistent CFU value range over time.

Comparing between the pre- and post-treatment values of the first and second barrels 1 and 2, respectively, connected to the regular treatment system, it is seen that the regular system is extremely efficient in decomposing relatively low concentrations of a biological mass in the water. For a higher concentration, the regular system still decomposes the biological mass well to very low CFU values but higher than the initial relatively low concentrations. This is understandable when normalizing the results according to the length of time that the system has been allowed to operate.

TABLE IV
Oct. 25/29, 2023 - Before Purification

| Barrel | | Dissolved O₂ | General Count | |
|---|---|---|---|---|
| No. | pH⁽¹⁾ | (mg/L)⁽²⁾ | (CFU/ml)⁽³⁾ | Comments |
| 1 | 7.1 | 7.26 | 8700 | |
| 2 | 7.2 | 6.95 | 24000 | |
| 3 | 7.1 | 7.23 | 18000 | Throughput of |
| | | | | incoming air - |
| | | | | 8 liter/min |
| 4 | 7.3 | 7.22 | 24000 | Throughput of |
| | | | | incoming air - |
| | | | | 16 liter/min |
| 5 | 7.1 | 7.25 | 34000 | |
| 6 | 7.3 | 6.9 | 60000 | |

Quality control terms:
⁽¹⁾pH measurements were made according to MOH Water Sampling guidelines.
⁽²⁾Dissolved O₂ measurements were made according to MOH Water Sampling guidelines.
⁽³⁾General count of microorganisms was made according to PP/SM - 9215 B standard.

TABLE V
Oct. 26/29, 2023 - After Purification

| Barrel | | Dissolved O₂ | General Count | |
|---|---|---|---|---|
| No. | pH⁽¹⁾ | (mg/L)⁽²⁾ | (CFU/ml)⁽³⁾ | Comments |
| 1 | 8.6 | 8.2 | <1 | |
| 2 | 8.5 | 8.3 | 41 | |
| 3 | 8.6 | 8.3 | 57 | Throughput - 8 |
| | | | | liter/min |
| 4 | 8.5 | 8.2 | 17 | Throughput - |
| | | | | 16 liter/min |
| 5 | 8.4 | 8.4 | 10 | |
| 6 | 8.4 | 8.4 | 111 | |

Quality control terms:
⁽¹⁾pH measurements were made according to MOH Water Sampling guidelines.
⁽²⁾Dissolved O₂ measurements were made according to MOH Water Sampling guidelines.
⁽³⁾General count of microorganisms was made according to PP/SM - 9215 B standard.

Comparison between barrels 5 and 6 in the higher extreme supports this line of analysis. This comparison shows an increase in the post-treatment CFU count by an order of magnitude. This is while the difference in the pre-treatment counts for these barrels is only by a factor of 2. This clearly suggests a non-linear relation between the level of water contamination and the efficiency of the water treatment system. The water treatment system should display significantly improved performance to handle heavily contaminated water and bring it to acceptable levels that makes it drinkable for farm animals. In these series of experiments, the modification in the magnetic field and to some extent also the interior cover for reflecting radiation proved to meet this standard without over burdening the system and keeping its dimensions, configuration as well as the physical model applied to it.

The following describes embodiments of the invention with particular reference to the modifications made to the chamber of the water treatment system in the instant invention that led to the experimental results detailed above. FIGS. 1-3 illustrate the general configuration of the water treatment system. FIGS. 4-6 illustrate the skeleton that carries the magnetic rings that generated the magnetic field and accommodate the UV radiation lamp. FIGS. 7-13 display the modifications introduced into the chamber of the water treatment system that amplified the strength of the localized magnetic fields, which in turn increased the purification performance of the system. As mentioned above, this increase in purification performance is attributed to increase in yield of radicalized molecular oxygen in the air flowing through the chamber. The increase is achieved while maintaining mainly the requirement of locality of the magnetic fields and the corresponding steady state of aggregates of molecular oxygen allotropes accumulated in these fields. Keeping these two conditions of the physical model, namely amplification of the magnetic fields to a level that still keeps their locality along the length of the chamber, is assumed to have produced the increase of yield of radicalized oxygen and level of purification of increasingly contaminated water.

### BRIEF DESCRIPTION OF THE DRAWINGS

FIG. 1 shows a schematic illustration of a box diagram of the water purification and treatment system.

FIG. 2 shows the internal design of the water purification system.

FIG. 3 shows a front view image of the water purification and treatment system.

FIGS. 4A-B show schematic design of the air ionization chamber assembly, where (A) shows a top perspective view of the external housing assembly, and (B) shows a side perspective view of both internal and external structures and assembly.

FIGS. 5A-D show the design of assembly parts of air ionization chamber. (A) shows exploded top perspective view of the external housing assembly parts; (B) is an exploded side perspective view of internal and external assembly parts; (C) and (D) show zoom-in views of (B) and (A) with and without the ferromagnetic rings, respectively, at the holding seating of the ferromagnetic rings.

FIGS. 6A-E show experimented configurations with and without magnetic rings, which are attached to the inner skeleton inside the ionization chamber.

FIG. 7 shows the double ring pairs configuration with three such pairs held on the skeleton and around the UV lamp at the center of the chamber.

FIG. 8 shows a closer view of the double magnetic ring pair configuration of the present invention.

FIGS. 9 and 10 show further closer views of the double magnetic ring pair distinguishing between the single rings in every double ring pack.

FIGS. 11-13 show a top view of the covered inner wall of the chamber.

### DETAILED DESCRIPTION OF THE DRAWINGS

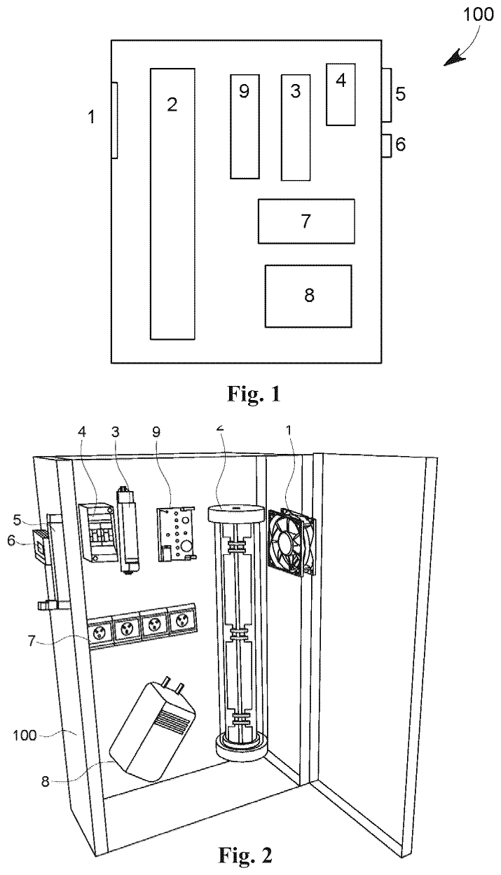

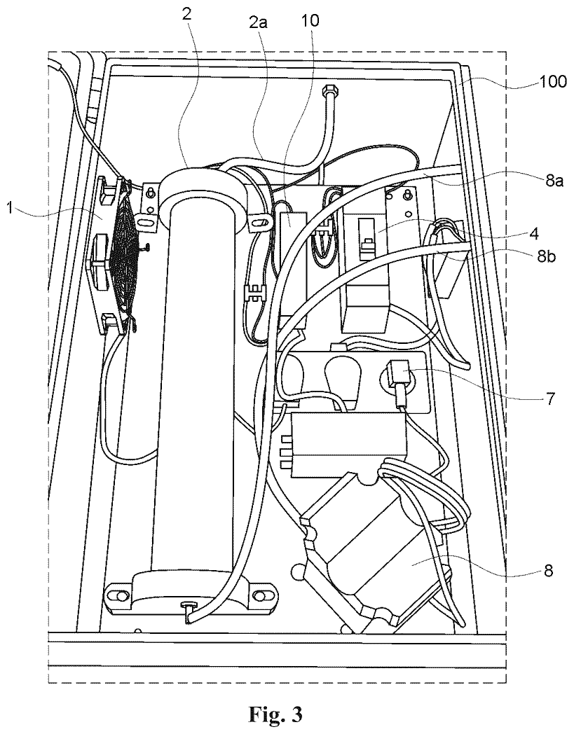

FIGS. 1 and 2 show schematic box diagram and design for water purification and treatment system (100), where a real image of one optional embodiment of the system is shown at FIG. 3. The water purification system main part comprises: an optional fan cooling system (1), which is required to thermally stabilize and regulate the temperature water purification and treatment system as a result of possible unwanted internal or external heating sources. Pending on thermal cooling requirements, the cooling system can employ an air fan, a water cooling or other cooling system; a cylindrical air flow ionization chamber (2) made of aluminium, PVC or other chemically inert material, coated with TiO₂ on its internal side; an electrical ballast (3) for a UV light lamp, with specifications of power (Watts, Amps, Volts), connected to the local power supply; an electrical breaker circuit (4), added to avoid overloading of the electrical current inside the system; a plurality of gas flow meter devices (5) that can be based on electrical or a mechanical flow rate measurement principles, where flow meters can be configured inside or outside the purification system box (100) and located anywhere inside or outside the purification and treatment site pending on system requirements. The gas flow meters monitor and regulate the current air gas flow volumetric rate inside the system (measured in values of Litter Per Minute, LPM). A plurality of power meter devices (6) are located in any location at the water purification and treatment site and further monitor and regulate the operational values, the system electrical power, voltage and electrical currents. In another embodiment this system is remotely controlled. A plurality of electrical outlets (7) enables power supply connections inside and outside the purification and treatment system. The system further comprises compressor air gas (8). A regular clean air enters into the compressor or the air is pre-filtered from impurities and contaminations before it enters the ionization chamber with a specific filtering system and is further compressed into the cylindrical tube ionization chamber (2) with the air compressor device (8) (filtering system not shown in the figure). The compressor pressure values range between 0.1 and 10 [bar] with a flow rate of 2-25 LPM. FIG. 3 shows one optional setup, in which the air compressor pump (8) is connected to gas flow meter devices (5) and through it to the ionization chamber with air pipes (8a, 8b), respectively. The ionization camber is connected to the external water reservoir inlet (not shown in the related figures) through air gas pipe (2a). To improve air intake into the ionization tube chamber, the compressor can be connected to an air diffuser and/or venturi air pipe line. In another embodiment, to improve air flow from the ionization chamber to the water reservoir, the air pipe (2a) is replaced with a venturi pipe line that guides it efficiently to contaminated water housing container. In another embodiment of the present invention, the radicalized air flow rate is enhanced by a secondary air compressor or vacuum pump, located at the output pipe (2a) at different positions. In such configuration, the secondary air compressor or vacuum pump, push or suck, respectively, the radicalized air toward the diffuser, which is located inside the treated water container or water reservoir. In a further embodiment of the present invention, the air compressor device is connected to the output pipe (2a) in proximity to its connection to the ionization chamber outlet. The connection is made with a T-shape air junction element. In this setup, the connection can optionally utilize a non-return air valve connected to the air compressor output and avoid any leak of radicalized air flow or leak into the compressor. The air that flows out of the compressor collides with the radicalized air and accelerates it toward the diffuser which is connected in proximity to its connection to the diffuser device. The connection is done through output pipe (2a) outlet, via a T-shape air junction element. A non-return air valve can be connected to avoid leak of radicalized air into the pump. The radicalized air is accelerated by the air pump toward output pipe outlet into the diffuser.

Furthermore, the system comprises a remote control and monitoring unit (9) that monitors and controls the system operational values versus their specified ones and can be mechanically or electronically switched between ON and OFF operating states. The monitoring unit monitors the voltage and power supply to the system and particularly voltage and power values of the UV lamp, fan, electronic flow meter and other units in the system.

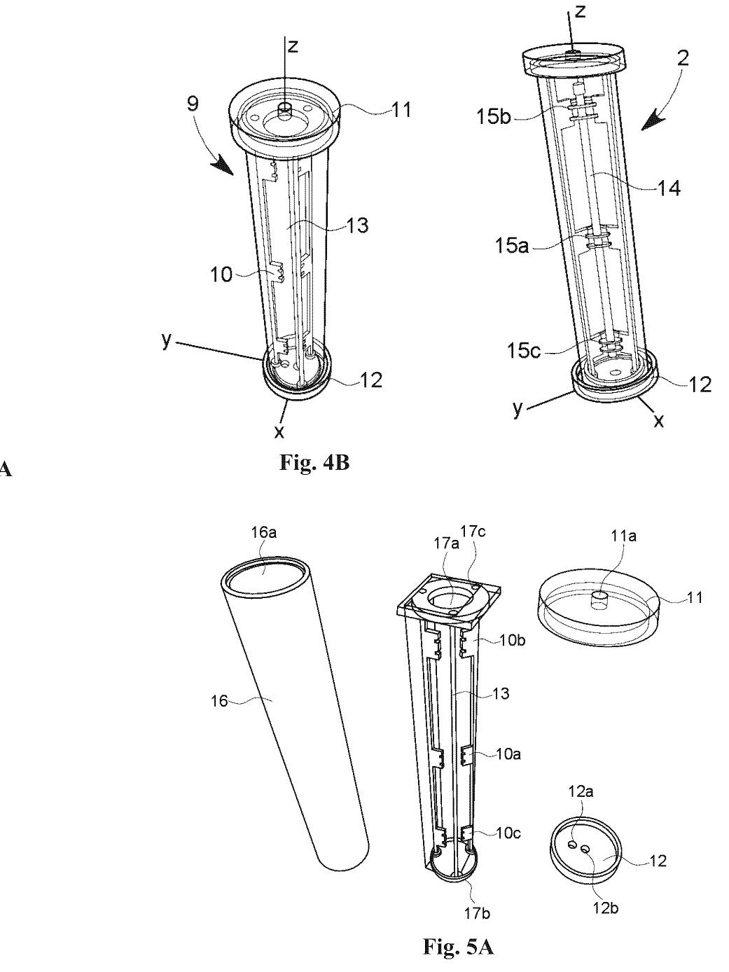

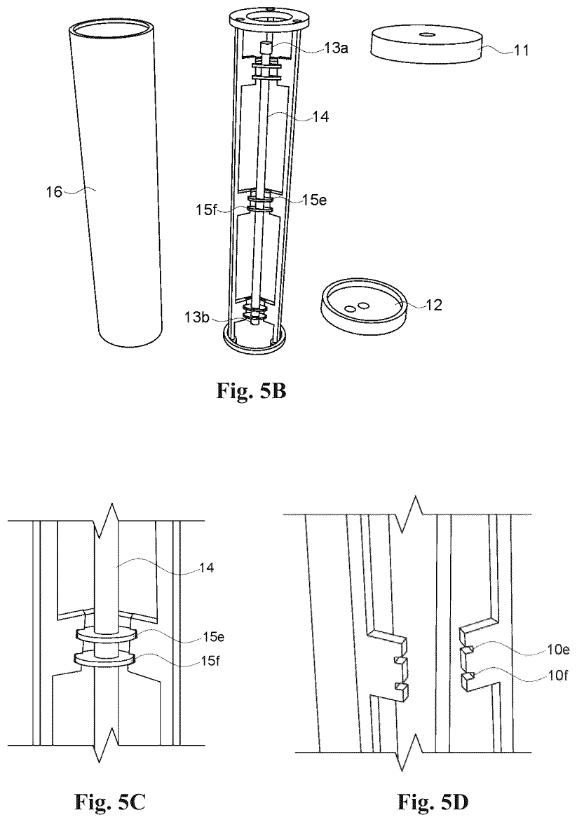

FIGS. 4A-B and 5A-D show schematic design of the air ionization chamber in its assembled and unassembled state, respectively. FIG. 4A shows a top perspective view of the external housing of the air ionization chamber, where its assembled parts are shown in FIG. 5A. FIG. 4B shows a side perspective view of the chamber internal and external structural design, where the assembled parts are shown in FIG. 5B. As shown in these figures, the air ionization chamber shown in FIGS. 4A and 5A, comprises: A cylindrical housing tube/cylindrical sleeve (16). The tube/sleeve may be made of aluminium and PVC (Polyvinyl chloride which is chemically inert) coated on its internal side with TiO₂ layer to avoid oxidation and damage by the flowing ambient and radicalized air; A frame/skeleton structure (13), with a cylindrical geometrical shape and symmetry. The skeleton may be made of aluminium stainless steel or any hard metal. The skeleton (13) is embedded inside the tube/sleeve housing structure (16). The frame/skeleton structure is designed with two holding elements (13a,13b) for holding the magnetic rings and an internal space for the UV light lamp (14). The skeleton may further comprise holding elements (10a,10b,10c) from top to bottom at selected distances from each other for holding ferromagnetic rings in a specific configuration (15a,15b,15c). The holding elements or seatings may be made of stainless steel and coated with titanium. The holding elements (10a, 10b, 10c) may form a single solid unit with the skeleton. The inner space in the skeleton for the UV lamp is essentially a cage formed by bars along the z-axis and around the centre of the skeleton. The space has openings in proximity to the skeleton bottom and top sides.

The magnetic field configuration comprises three sets of concentric cylindrical ferromagnetic rings (15a, 15b, 15c) arranged at selected polarity, occupying an effective small portion of the total volume of the tube chamber. The rings are positioned along the z-axis of the skeleton, particularly at top and bottoms sides and center of the tube chamber main axis, where each set comprises magnetic negative and positive poles rings (15e, 15f). In one particular embodiment, the rings are arranged with the same polarity. Generally, the tube and housing are made from chemically and mechanically durable or resistant materials. The UV lamp (14) can comprise two internal lamps that radiate at two wavelength ranges of 180-195 [nm] and 240-280 [nm], and can be designed and produced in two different types and configuration of either mercury filament or LED light. Further, the lamp electrical connector configurations can include 2 or 4 pins and be located at different locations at their sides depending on the light lamp type. As shown in FIGS. 5C and 5D, each of the ferromagnetic ring seating comprises two cylindrical slots (10e,10f) configured to mechanically hold two corresponding ferromagnetic rings (15e,15f). This design yields a closely packed configuration for the ferromagnetic rings and the UV lamp (14) located along the central longitudinal axis of the air ionization chamber. The ferromagnetic rings are configured to be located close to the UV lamp radiation source surrounding it at three main locations along the central axis of the air ionization chamber, thus creating three main coupling ionization impact points between the UV radiation and the flowing ambient air. Interaction specifically impacts the paramagnetic oxygen component along the ambient air trajectory in the air ionization chamber. The external sleeve structure (16) is mechanically attached to top (11) and bottom (12) covers, disks shaped, made of aluminium or stainless steel materials and further coated by TiO₂ layer. The top and bottom covers/caps are configured with one or two holes respectively. The central holes in the top (11a) and bottom (12a) covers are used as the inlet and outlet for the air flowing through ionization camber, respectively. The bottom housing cover may further be designed with a special second input hole (12b) to enable insertion of electrical wiring into and out of the air ionization chamber. In another embodiment, the internal chamber area, including the housing frame (13), holding elements and chamber cover internal side are coated with TiO₂ to avoid oxidation and damage by the flowing gas inside the chamber.

To enable electrical and vacuum functionalities the inlet and outlet holes are made out of SS (Stainless Steel) resistant material. The covers are mechanically attached to aluminium/SS housing frame (13) at its top and bottom bases (17a, 17b) and external tube structure (16). The external connections of the ionization chamber are sealed with Teflon to ensure the required vacuum condition for air that flows inside the chamber. The attachment to the top and bottom bases (17a, 17b) are done with special screws, inserted into holes (17c) at the frame top and bottom sides. A plurality of adapter and fastening elements are added to the air and electrical inlets and outlets to enable insertion of electrical input and output lines without affecting internal atmospheric pressure. These elements are also used to enable removal of air from the ionization chamber through specially designed air outlets.

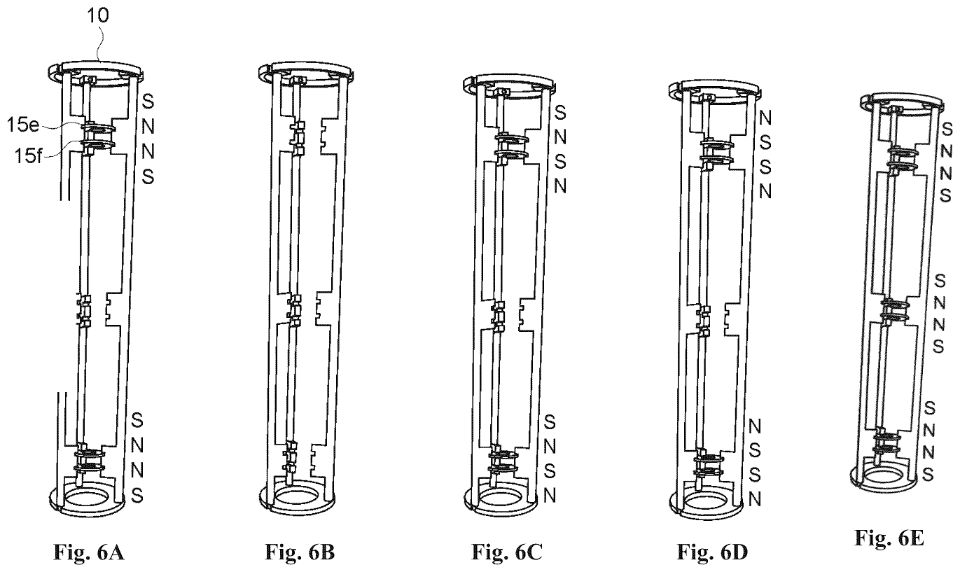

FIGS. 6A-E show perspective side view images of different configurations of the magnetic rings inside the ionization chamber. The magnetic rings are carried by holding elements (10) of the skeleton inside the ionization chamber. As shown in FIG. 4B, the magnetic rings are symmetrically aligned relative to the main longitudinal central axis of the holding element (10) around the UV lamp (14) and the main central axis of the ionization cylindrical chamber. FIG. 6A shows a perspective side view image of the anti-symmetric magnetic field configuration comprising two magnetic sites located at two sides of the carrier holding device (10) inside the ionization chamber. In this configuration, each of the magnetic sites comprises two magnetic rings (15e, 15f). The ring polarity is marked as (SN, S=South, N=North), where each ring is positioned in opposite magnetic polarization with its norths pole at its proximal side and South Pole at its distal side, i. e. (SN) (NS). This configuration is marked as the reference configuration in one preferred embodiment of the present invention. FIG. 6B shows a perspective side view image of the magnetic field configuration comprising ionization chamber with no magnetic fields. FIG. 6C shows the symmetric configuration of the magnetic field in another embodiment of the present invention. The related configuration comprises two magnetic sites, which are located at two sites of the holding element (10) inside the ionization chamber. Each magnetic site comprises two magnetic rings (15e, 15f). The magnetic rings in each site in this configuration are positioned in the same magnetic polarization direction, which is directed from ionization chamber inlet to its outlet from north to south poles, respectively, i. e. (NS) (NS). FIG. 6D shows another optional anti-symmetric magnetic field configuration comprising magnetic rings in another embodiment of the present invention. This configuration comprises two magnetic sites located at the two sides of the holding element (10) and ionization chamber. Each site comprises two magnetic rings (15e, 15f), which are positioned in opposite magnetic polarization with their south magnetic pole at their proximal sides and north magnetic pole at their distal sides, (NS) (SN). FIG. 6E shows the anti-symmetric magnetic field configuration comprising magnetic rings in another preferred embodiment of the present invention. The configuration comprises three magnetic sites located along the central axis and at two sides of the holding element (10), as shown in FIG. 4E. In this configuration, each magnetic site comprises two magnetic rings (15e, 15f), which are positioned in an opposite magnetic polarization with their norths magnetic pole at their proximal side and south magnetic poles at their distal sides, i.e., (SN) (NS) three magnetic sites.

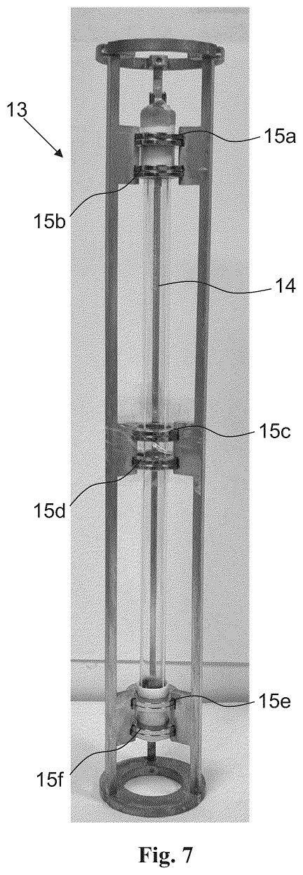

FIG. 7 shows the double ring pairs (15a,b; 15c,d; 15e,f) configuration with three such pairs held on the skeleton (13) and around the UV lamp (14) at the center of the chamber (2). The multiplication of the number of rings in every site is compatible with the basic structure and dimensions of the skeleton and does not occupy a large significant volume. As a result, it does not distort the incoming and outgoing flow of air through the chamber and the interaction of UV radiation with oxygen molecules.

The main impact is in the number and mean lifetime of radicalized oxygen molecules, which translates to improved purification of water as shown in the results in the tables and analysis of experiments above.

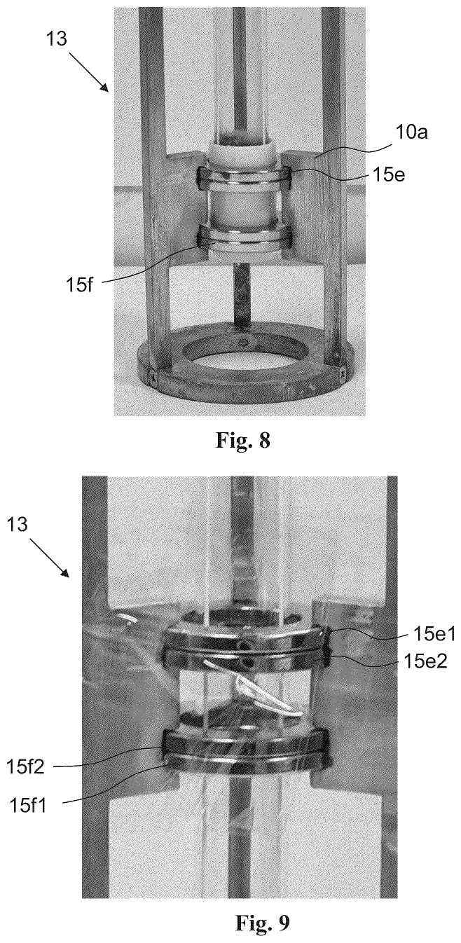

FIG. 8 shows a closer view of the double magnetic ring pair (15e,f) configuration of the instant invention. Holding element (10a) has sufficiently large spaces that accommodate two rings in every space, thereby increasing the strength of the magnetic field that every pair generates. The pairs of double rings can be oriented in any one of the configurations of magnetic poles as exemplified in FIGS. 6A-D and detailed above. We assume that different pole arrangements generate different configurations of magnetic fields. This could translate to different values of the aggregate of radicalized oxygen molecules such as concentration, number and mean lifetime. However, the series of experiments suggests that this characteristic of the magnetic fields is not a significant factor that affects the final purification outcome.

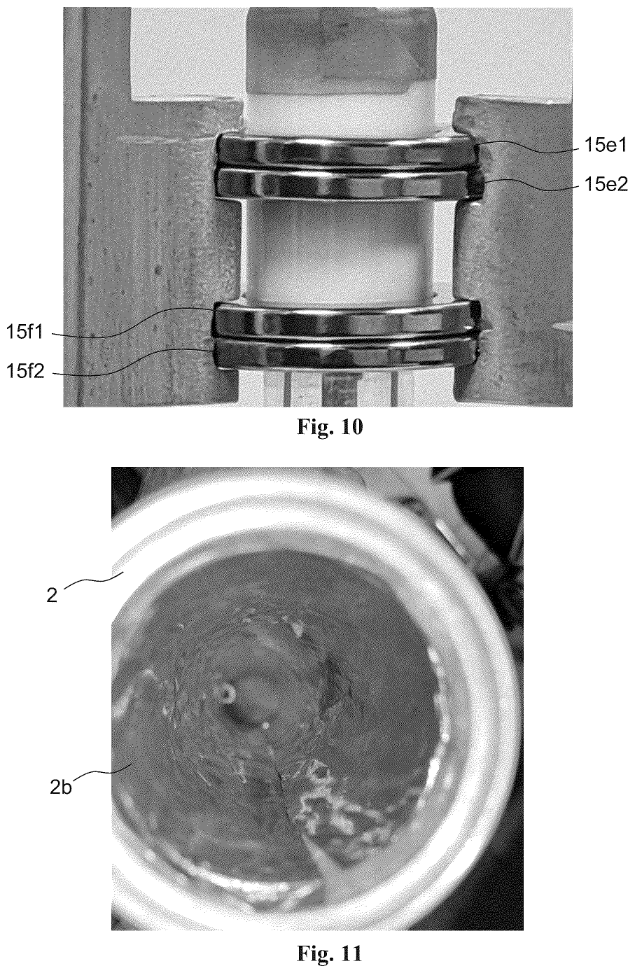

FIGS. 9 and 10 show further closer views of the double magnetic ring pair distinguishing between the single rings in every double ring pack (15el,2,f1,2). The rings in every pack of double rings are compatible with the space of the holding element that allows firmly holding them in contact with each other for generating the magnetic pole together with the parallel pack of double rings. These closer views clearly show that doubling the rings in a localized configuration does not change the volume, which the magnetic rings occupy in the chamber, or perturbs the flow of air inside. Instead it amplifies the strength of the magnetic field and positively influences the generation and sustainability of the radicalized oxygen molecules, which then translates to improved water purification.

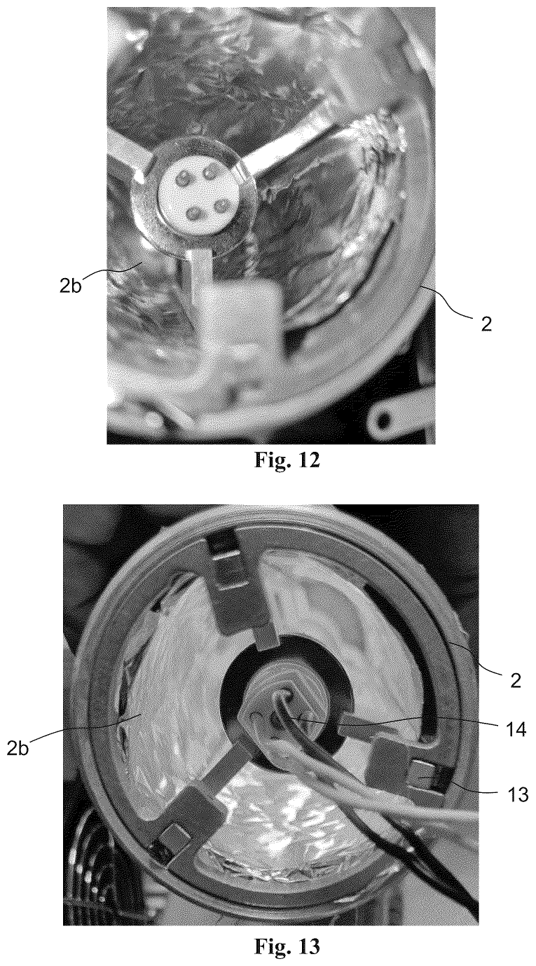

FIGS. 11-13 show a top view of the covered inner wall of the chamber (2). An aluminium foil (2b) is used to cover the inner wall and reflect the UV radiation from the UV lamp back to the chamber. Such inner cover was assumed to multiply the number of interaction of the radiation with oxygen molecules in the incoming air and eventually obtain a steady state of localized aggregates of radicalized molecular oxygen in the local magnetic fields. As a result, the radicalized oxygen should have a greater mean lifetime and number of units. FIG. 13 shows a look from the top on the chamber (2) with the aluminium foil covered (2b) inner wall in an active state of the UV lamp (13). As seen, the foil reflects the UV radiation efficiently. This mechanism for intensifying radiation inside the chamber and particularly within the local magnetic fields along the center axis of the chamber was believed to contribute to the yield of radicalized molecular oxygen. However, the experimental results, as detailed and analyzed above, suggest that this too is not a major factor in obtaining higher yields of radicalized molecular oxygen and corresponding water purification. It is rather the strength of the magnetic fields combined with their locality along the length of the chamber that leads to such improved results.

The water purification results above support our assumption that amplifying the local magnetic fields with the double ring pairs and only to a limited extent intensifying UV radiation with back reflection result in improved water purification. Water purification measurements were taken in water with a significant concentration of biological, inorganic and organic impurities. To identify the improvement in using the system of the present invention, the system of WO 2019/135239 and the system of the present invention operated on the same water container that was divided into two identical parts. A control measurement was taken before operation. Samples were taken from the water tank and kept at 2-8° C. The results of all measurements are summarized in the tables below. All measurements were made in a certified lab according to nationally acceptable standard of ISO/IEC 17025.

The results of the previous and improved devices show a significant change relative to the control in all parameters. The decrease in pH on the surface of the water in the tank from 9.7 to below 9 (8.7, 8.4) suggests that the water turned more acidic, probably due to oxidation reactions that took place in water with the water contaminants and water molecules. The reduction of dissolved oxygen on the surface of the water from 14.0 to almost half this value, 7.88 and 7.66, points to the increase of oxygen related chemical reactions in the bulk of water medium and the conversion of oxygen to other oxidant compounds that remain in water or precipitate to the tank floor. The reduction in the number of bacteria in the contaminated water by between 10% and 33%, from 18,000 to 16,000 and 12,000, respectively, demonstrate the excellent efficiency of purifying water with radicalized oxygen.

Comparing the performance of the previous and improved devices, we see a noticeable positive change in the total count of bacteria in the water. A further decrease of CFU per volume is observed for the improved water purification device. The relative decrease from the previous device is 25% and over three times relative decrease from the control. This is a clear indication to the greater efficiency of the configuration of the improved device with the UV reflection cover and double magnetic ring pairs. The reduction in dissolved oxygen on the surface of the measured samples show a slight advantage to the improved device, suggesting a slightly higher volume of oxygen molecules that diffuse to the water surface and released to the surface. Finally, the reduction in surface pH relative to the control is also slightly less in the water treated with the improved device, possibly indicating that a higher amount of the radicalized oxygen molecules react in the water bulk and are not wasted to the surrounding when diffusing up to the water surface. The clear conclusion from these results combined is that the amplification of interaction of oxygen molecules due to back reflection of UV radiation and the intensifying of the local magnetic fields with the double ring pairs are the causes for the improved water purification. This obviously proves the technical and functional advantages of the improved water purification device of the present invention over the previous one.

1. A water purification system comprising:
a chamber comprising an inlet and an outlet for flowing incoming and outgoing air into said chamber and out of said chamber and into a water-containing tank;
at least one UV radiation lamp;
at least one of double magnetic ring pair; and
a skeleton configured for occupying center volume of said chamber from top to bottom around central longitudinal axis of said chamber, said skeleton comprising inner space for accommodating said at least one UV radiation lamp and holding elements for holding said at least one double magnetic ring pair around said at least one UV radiation lamp,
wherein an inner diameter of bases of said skeleton is smaller than an inner diameter of said housing sleeve, said housing sleeve is connected at opposite ends to top and bottom covers, said top and bottom covers are provided each with respective central holes, and wherein every pair of said double magnetic rings generates a local magnetic field upon placing said at least one double magnetic pair on holding elements on said skeleton, said local magnetic field does not overlap or at least minimally overlap a local magnetic field generated by a neighbour double pair of magnetic rings,
wherein said purification system comprises a concentric configuration to minimally perturb profile and a distribution of said incoming and outgoing air, said at least one double magnetic ring pair are positioned in parallel relative each other and configured to induce maximal concentric magnetic flux field on molecules of said flowing incoming and outgoing air,
wherein said at least one double magnetic ring pair is configured to intensify said local magnetic fields, and
wherein said at least one double magnetic ring pair are configured to increase number and mean lifetime of radicalized oxygen molecules inside said chamber.

2. The water purification system according to claim 1, further comprising a UV radiation reflection cover on inner wall of said chamber, wherein said UV radiation reflection cover is configured to amplify interaction of UV radiation with oxygen molecules in said incoming air, wherein said UV radiation reflection cover is configured to increase number and mean lifetime of radicalized oxygen molecules inside said chamber.

3. The water purification system according to claim 1, further comprising
compressor air pump for injecting air into said chamber.

4. The water purification system according to claim 1, further comprising electrical ballast UV radiation source, said UV radiation source is connected to local power supply with the related specifications of power.

5. The water purification system according to claim 1, wherein said at least one UV radiation lamp comprises two lamps with two wavelength ranges of 180-195 [nm] and 240-280 [nm].

6. The water purification system according to claim 1, wherein said at least one UV radiation lamp is a mercury filament or LED light with electrical connectors of two or four pins.

7. The water purification system according to claim 1, wherein said chamber is made of a conductive material coated with a chemically inert material.

8. The water purification system according to claim 1, wherein said chamber comprises a cylindrical housing, said cylindrical housing tube is embedded within said chamber.

9. The water purification system according to claim 1, wherein said chamber further comprises external sleeve and top and bottom covers mechanically attached to top and bottom sides of said external sleeve and close top and bottom ends of said chamber.

10. The water purification system according to claim 1, wherein said chamber further comprises a plurality of electrical outlets for power supply connections into and out of said system, said outlets are sealed with Teflon for vacuum.

11. The water purification system according to claim 1, further comprising electrical breaker circuit for avoiding overloading of electrical current in said system.

12. The water purification system according to claim 1, further comprising a plurality of gas flow meters, said gas flow meters are mounted inside or outside a box encapsulating said chamber.

13. The water purification system according to claim 1, further comprising a plurality of power meter devices for monitoring and regulating electrical power, voltage and current operational values of said system.

14. The water purification system according to claim 1, further comprising a plurality of fan cooling systems.

15. The water purification system according to claim 1, further comprising remote control unit for controlling operational values versus specified values of said system, said unit is configured to switch between on and off operating states of said system, mechanically or electronically, and monitor voltage, electrical current, power supply and related devices of said system.

16. The water purification system according to claim 14, wherein said devices are selected from said at least one UV lamp, a fan and electronic flow meter.

17. The water purification system according to claim 1, further comprising a venturi pipe attached to said outlet of said chamber for transporting radicalized/excited and ambient air into a treated water reservoir.

18. The water purification system according to claim 1, further comprising a water container or water reservoir in fluid communication with said chamber.

19. The water purification system according to claim 1, wherein said chamber has a cylindrical geometrical shape with a housing sleeve and a housing frame with corresponding cylindrical geometrical shape.

20. The water purification system according to claim 1, comprising three pairs of double magnetic rings arranged in identical polarity configuration at top and bottom ends, and center of and around main central longitudinal axis of said chamber, wherein each one of said pairs of double magnetic rings comprises two rings with negative polarity and two rings with positive polarity, said polarity configuration is anti-symmetric configuration, said rings are mechanically held by said holding elements.

21. The water purification system according to claim 19, wherein said double magnetic ring pairs generate magnetic field strength in the range of 10⁻³ to 10⁶ gauss said range is sufficient to induce high magnetic flux in said chamber and excite/radicalize incoming ambient air.

22. The water purification system according to claim 1, wherein said skeleton comprises outer longitudinal bars extending from top to bottom of said skeleton around inner space for accommodating said at least one UV radiation lamp, and holding elements extending inwardly from said outer bars and comprising recesses for holding said at least one pair of double magnetic rings around said at least one UV radiation lamp, said outer bars and holding elements forming a single solid unit of said skeleton.

23. The water purification system according to claim 1, wherein said chamber and skeleton are made from aluminum.

24. The water purification system according to claim 23, wherein inner surface of walls of said chamber and said skeleton are coated with TiO₂.

25. The water purification system according to claim 23, wherein inner surface of walls of said chamber is coated with PVC.

26. The water purification system according to claim 3, further comprising an air diffuser connected to said compressor air pump on one end and to said chamber on other end.

27. The water purification system according to claim 1, further comprising a pre-filtering apparatus for cleaning ambient incoming air from impurities and contaminations before injecting it into said chamber.

28. The water purification system according to claim 1, further comprising a diffuser connected to an outlet of said chamber for diffusing radicalized/excited air into a water reservoir.

29. The water purification system according to claim 1, wherein said magnetic rings are made of ferromagnetic materials made from rare earth magnets.

30. The water purification system according to claim 29, wherein said materials are selected from Nd₂Fe₁₄B, SmCo₅ Sm₂Co₁₇, composite magnetic materials, BaFe₁₂O₁₉, MnBi, Ce(CuCo)₅, strong permanent magnets made from aluminium, nickel, cobalt and iron and comprising small amounts of Cu, Ti and Nb, and ferrite materials of ferrimagnetic materials such as Fe₂O₃, and Fe₃O₄.

31. The water purification system according to claim 29 or 30, wherein one pack of two rings of said at least one pair of double magnetic rings is made from one of said magnetic materials and second pack of two rings of said at least one pair of double magnetic rings is made from a metallic material that can be magnetized under induced external magnetic field.

32. The water purification system according to claim 31, wherein said metallic material is iron or steel.

33. The water purification and treatment system according to claim 1, further comprising a water cooling system.

34. The water purification and treatment system according to claim 1, wherein said UV radiation reflection cover is selected from aluminum foil, stainless steel and UV radiation reflecting colors.

35. The water purification system according to claim 1, wherein said system is configured to purify water in water reservoirs, systems and conduits.

36. The water purification system according to claim 35, wherein said water reservoirs, systems and conduits are selected from drinking water supply systems, swimming pools and water piping.
